(19) United States
(12) Patent Application Publication
(10) Pub. No.: US 2010/0093210 A1
(43) Pub. Date: Apr. 15, 2010

(54) COAXIAL ELECTRICAL CONNECTOR

(75) Inventor: Qingyong Zeng, Kunshan (CN)

Correspondence Address: VIDAS, ARRETT & STEINKRAUS, P.A., SUITE 400, 6640 SHADY OAK ROAD, EDEN PRAIRIE, MN, 55344, US

(73) Assignee: KUNSHAN JIAHUA ELECTRONICS CO., LTD., Kunshan (CN)

(21) Appl. No.: 12/501,123

(22) Filed: Jul. 10, 2009

(30) Foreign Application Priority Data
Oct. 10, 2008 (CN) 200820161685.8
Oct. 13, 2008 (CN) 200820186143.6
Oct. 15, 2008 (CN) 200820186229.9

(51) Int. Cl. H01R 9/05; H01R 13/40

(52) U.S. Cl. 439/578; 439/725

(57) ABSTRACT

A coaxial electrical connector is provided with a metallic shell, an insulator received in a hollow portion enclosed by the metallic shell, and a terminal member received in a through-hole of the insulator. The terminal member has a first gap for inserting a wire stock, while the insulator and the metallic shell are provided with a second gap and a third gap respectively for the wire stock to pass through. The terminal member includes a flat contact for supporting the wire stock, a fixing portion for fixing the terminal member in the through-hole of the insulator, and a connecting member having an inserting gap. The flat contact is formed with frictional stripes at the surface contacting with the wire stock, making the coaxial electrical connector possess a stronger holding force for the wire stock, and the ill contact caused by loose of the wire stock be prevented.

### FIELD OF THE INVENTION

The present invention relates to an electrical connector for connecting two members with a wire stock, particularly to one that can be used in the transmission of high frequency signals.

### BACKGROUND OF THE INVENTION

High frequency (hf) coaxial electrical connector is a device adopted to connect two members with a wire stock in transmission of high frequency signals and presently finds its main application in fields like mobile phone, bluetooth, wireless network, and electronic measuring instruments. Existing coaxial electrical connectors are unsatisfactory in that the wire stock is liable to loose between the terminal member and the cover, leading to unexpected open circuit and low reliability. Besides, these connector products are difficult to assemble, and always assembled with high inferior probability, resulting that the production cost holds very high. With the above mentioned insufficiencies, it is very hard for present electrical connectors to meet the requirements of the rigorous market.

### SUMMARY OF THE INVENTION

Accordingly, the present invention is to provide a coaxial electrical connector with an improved terminal which possesses a strong holding force for the wire stock, preventing the wire stock from loosing.

In order to achieve the object set forth, a coaxial electrical connector is provided, in accordance with the present invention, mainly comprising a metallic shell, an insulator received in a hollow portion enclosed by the metallic shell, and a terminal member received in a through-hole of the insulator. The terminal member has a first gap for inserting a wire stock, while the insulator and the metallic shell are provided with a second gap and a third gap respectively for the wire stock to pass through. The terminal member includes a flat contact for supporting the wire stock, a fixing portion for fixing the terminal member in the through-hole of the insulator, and a connecting member having an inserting gap. The flat contact extends along the inserting direction of the wire stock and is formed with frictional stripes at the surface contacting with the wire stock.

Compared with the prior art, the terminal member of the present invention is formed with frictional stripes, strengthening the holding force for the wire stock. While the wire stock is steadily held, no loosing or slipping will occur and the transmission of signals will not be influenced. Therefore, the electrical connector according to the present invention can cater to the requirements of the market.

These and other embodiments which characterize the invention are pointed out with particularity in the claims annexed hereto and forming a part hereof Other objects, advantages and novel features of the invention will become more apparent from the following detailed description when taken in conjunction with the accompanying drawings.

### BRIEF DESCRIPTION OF THE DRAWINGS

FIG. 1 is a perspective view of the coaxial electrical connector in accordance with the present invention;

FIG. 2 is an exploded drawing of the coaxial electrical connector as shown in FIG. 1;

FIG. 3 is a perspective view of the terminal member of the coaxial electrical connector in accordance with the present invention;

FIG. 4 is a perspective view of the insulator of the coaxial electrical connector in accordance with the present invention;

FIG. 5 is another perspective view of the insulator as shown in FIG. 4;

FIG. 6 is a perspective view of the metallic shell of the coaxial electrical connector in accordance with the present invention;

FIG. 7 is a cross-section view of the coaxial electrical connector in accordance with the present invention before the cover of the metallic shell being bended;

FIG. 8 is a cross-section view of the present invention when the cover of the metallic shell is bended;

FIG. 9 is a schematic view showing the terminal member being received in the insulator;

FIG. 10 is a cross-section view taken along line A-A of FIG. 9; and

FIG. 11 is a schematic view showing the assembly of insulators by way of bridging.

Wherein:

1. terminal member; 11. first gap; 13. flat contact ;14. connecting member; 140. leg; 141. inserting gap; 15. fixing portion; 150. first crooked arm 151. first blocking point; 152. second crooked arm; 153. second blocking point; 16. frictional stripes; 160. recesses; 17. sight hole;

2. insulator; 21. through-hole ; 22. second gap; 23. extending portion; 231. groove; 232. protrusion; 25. receiving slot; 26. plug; 260. plane; 27. linking hole;

3. metallic shell; 31.hollow portion; 32. cover; 321. wing; 33. packing member; 331. first sheet ; 332. second sheet ;3321. bulge; 34. third gap; 35. projecting member; 333.bending notch; 334. tuck-ups; 341. clamping arm; 342. hook;

4. wire stock.

### DETAILED DESCRIPTION OF THE INVENTION

While this invention may be embodied in many different forms, there are described in detail herein specific embodiments of the invention. This description is an exemplification of the principles of the invention and is not intended to limit the invention to the particular embodiments illustrated. Reference will now be made in detail to the preferred embodiment of the present invention.

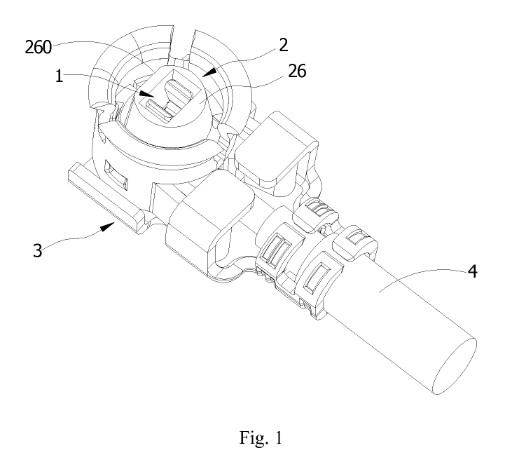

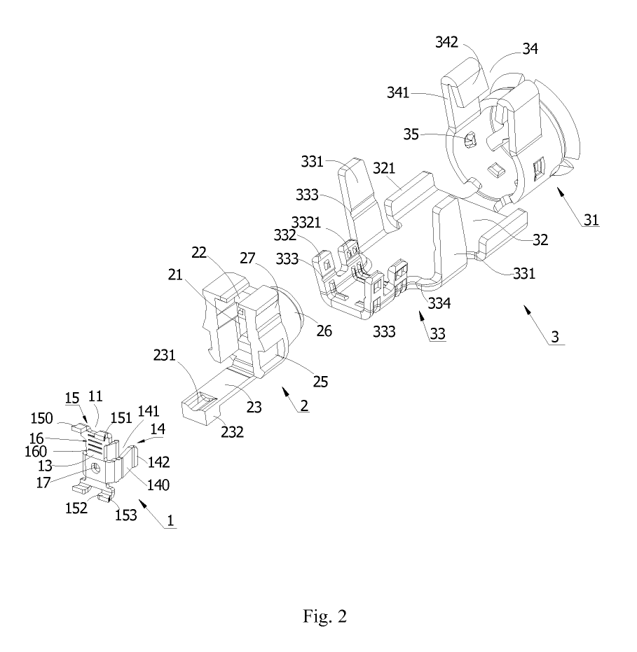

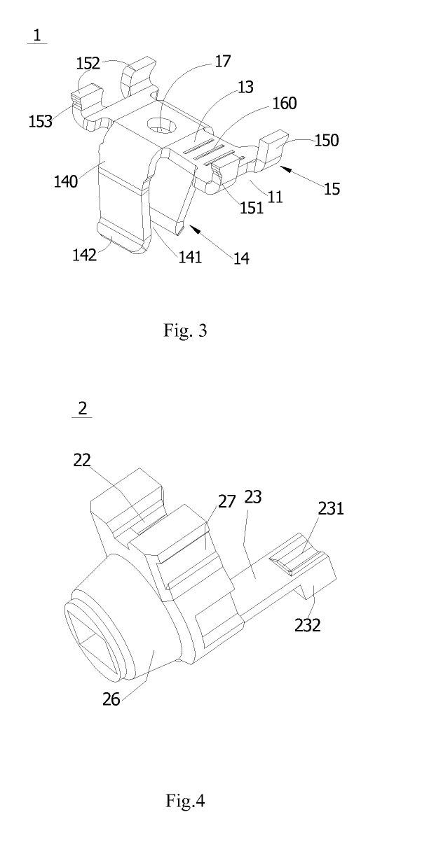

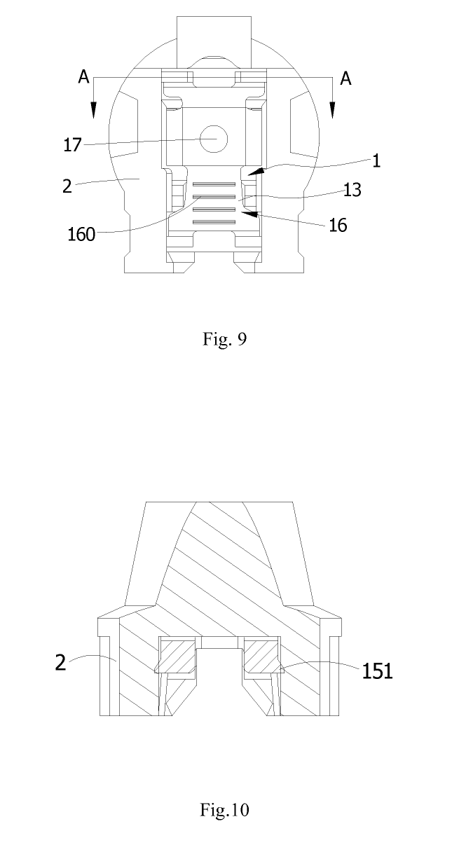

Referring to FIGS. 1-2, the coaxial electrical connector of this embodiment comprises a metallic shell 3, an insulator 2 received in a hollow portion 31 enclosed by the metallic shell 3, and a terminal member 1 received in a through-hole 21 of the insulator 2. When the connector needs to be used, a wire stock 4 having a core wire and a shielding layer can be inserted into the electrical connector with the core wire of the wire stock 4 contacting with the terminal member 1 and the shielding layer of the wire stock 4 conducting with the metallic shell 3. Here follows a detailed description of the structure and connecting relationships of the connector in conjunction with FIGS. 2-11.

As seen in FIGS. 2, 3, 9 and 10, the terminal member 1 of this embodiment comprises a flat contact 13 extending along the inserting direction of the wire stock 4, a fixing portion 15 used to position the terminal member 1 in the through-hole 21 of the insulator 2, and a connecting member 14 with an inserting gap 141. The fixing portion 15 at least include a pair of first crooked arms 150 formed at one end of the flat contact 13 and a pair of second crooked arms 152 formed at the other end of the flat contact 13 Preferably, the two pairs of crooked arms are symmetrically set with each crooked arm turning upwards from part of the corresponding end of the flat contact 13. Further, each of the first crooked arm 150 is formed with a plurality of first blocking points 151 at the surface facing the insulator 2, so that the terminal member 1 can be tightly positioned in the insulator 2 by the interference between the first blocking points 151 and the outside wall of the insulator 2. The second crooked arm 152 is provided with a plurality of second blocking points 152 which penetrate into and interfere with the outside wall of the insulator 2, further enhancing the stability of the terminal member 1 in the insulator 2.

A U-shaped first gap 11 is formed between the pair of first crooked arms 150 mentioned above for inserting the wire stock 4, that on one hand, ensures the contact of the wire stock 4 with the flat contact 13, and on the other hand, clamps the wire stock 4 tightly, so that the wire stock 4 is not liable to slip. The flat contact 13 is formed with frictional stripes 16 at its upper surface adjacent to the first crooked arms 150. The frictional stripes 16 can be of various forms having the feature of improved holding force for the wire stock 4. In the embodiment as shown in FIG. 2, the frictional stripes 16 are formed by a plurality of elongated recesses 160 spaced lengthwise on the upper surface of the flat contact 13. When inserted in the terminal member 1, the wire stock 4 has part of its surface squashed into the recesses 160, as a result of which, the wire stock 4 is not liable to slip, preventing the transmission of signals from being cut down. Besides, the flat contact 13 is provided with a sight hole 17 at the center. Through the sight hole 17 one can easily see whether the wire stock 4 arrives at the target place or not during a packing process.

The connecting member 14 of the terminal member 1 comprises an inverted U-shaped portion defined by two legs 140 turning downwards from the two lateral sides of the flat contact 13. The inserting gap 141 is formed between the two legs 140 narrowing gradually from the top to down, such that the inserting gap 141 is bell-mouthed ensuring the successful insertion of a corresponding plug and a stable contacting state. Additionally, the free end of the leg 140 bends away from the inserting gap 141 forming a crimping 142 to ensure a smooth insertion of a corresponding plug.

Referring to FIGS. 2, 4 and 5, the insulator 2 according to this embodiment as shown is made of plastic to gain elasticity. Besides the through-hole 21, the insulator further has a second gap 22 which is interconnected with the first gap 11 for the wire stock 4 to pass through.

In some cases, the connector further comprises an extending portion 23 with its lower end being connected with the insulator 2 and its upper end free. The extending portion 23 is twistable relative to the insulator 2 with its upper end having a groove 231 at the surface facing the wire stock 4 and a protrusion 232 at the surface facing the metallic shell 3. When packing the wire stock 4, the groove 231 and the protrusion 232 press tightly against the wire stock 4 and the metallic shell 3 respectively, so that a good contact between the wire stock 4 and the terminal member 1 is ensured.

As can be seen in FIG. 4, the insulator 2 is provided with a hollow and cone-shaped plug 26 lying below the through-hole 21 with one of the outer side surfaces being a plane 260. The cone-shaped plug 26 can be connected with a corresponding member smoothly, while the plane 260 makes unqualified scraping be avoided.

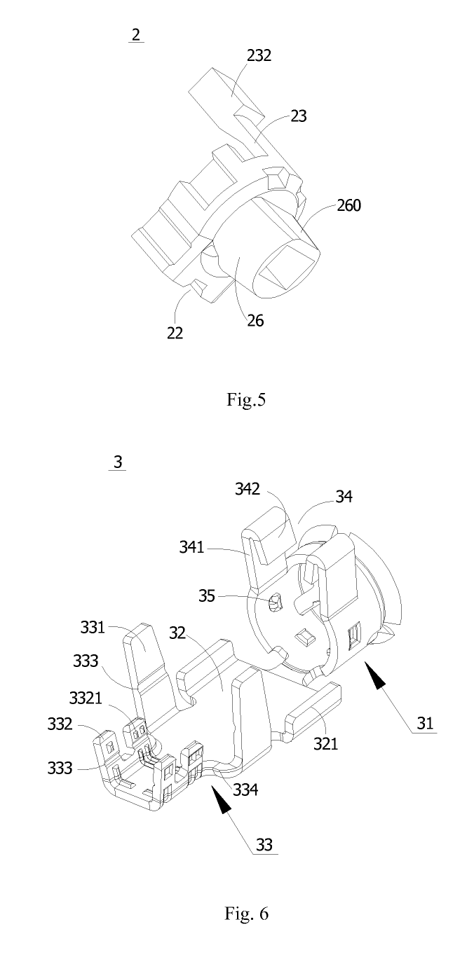

Referring to FIGS. 2 and 6, the metallic shell 3 is made of cobber material and has a hollow portion 31 for accommodating the insulator 2, a twistable cover 32 which can envelope one port of the hollow portion 31 when bended, wings 321 set at the cover 32 bilaterally for fastening the hollow portion 31, and a packing member 33 extending upwardly from the upper end of the cover 32 for the wire stock 4 to be wrapped therein. The packing member 33 comprises a twistable first sheet 331 and a couple of twistable second sheets 332 lying above the first sheet 331. Tuck-ups 334 are formed at the joint of the first sheet 331 and the second sheet 332 to enhance the intension there, which ensures that no distortion of the joint would cause ill contact. The second sheet 332 is formed with bulges 3321 at the inner side which can enhance the holding force for the wire stock 4, thus preventing the wire stock 4 from being drawn out. In addition, the first sheet 331 and the second sheet 332 are both pressed to form a bending notch 333 at the bending area, which makes the assembly of the product more convenient and the final product more agreeable.

The inner sidewall of the hollow portion 31 of the metallic shell 3 is set with several projecting members 35, while the insulator 2 is set with mating slots 25 accordingly for embedding the projecting members 35. Meanwhile, the metallic shell 3 further comprises a pair of clamping arms 341 between which the third gap 34 for insertion of the wire stock 4 is formed. The clamping arms 341 are set at the outside wall of the hollow portion 31 with the distal end from the hollow portion 31 bending inwards forming a hook 342. With two hooks 342, the insulator 2 is prevented from shaking transversely, which is essential to a reliable contact between the insulator 2 and its corresponding connecting member.

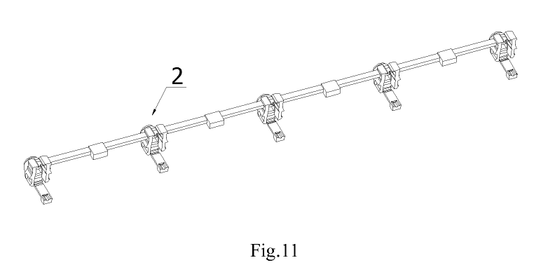

Again, Refer to FIGS. 2 and 11, the insulator 2 is formed with a linking hole 27, so that several insulators 2 can be connected together in a bridging manner, which can conquer the assembling difficulty due to tiny volume.

The specific assembly process of the connector according to this embodiment is as follows:

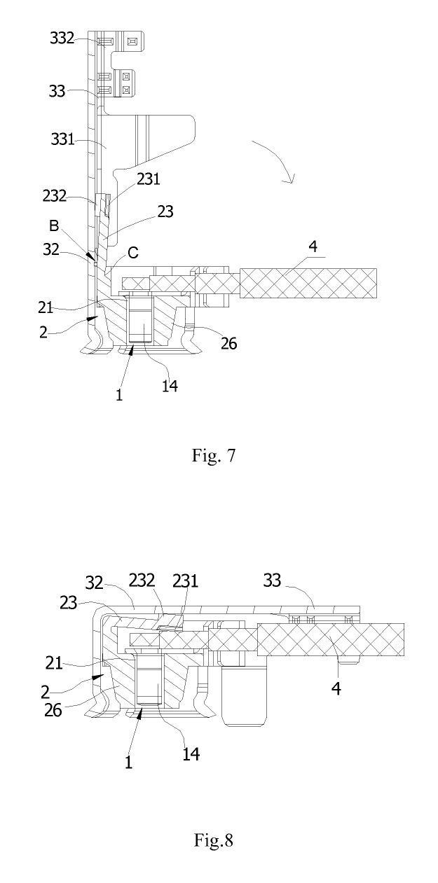

Firstly, mount the terminal member 1 in the through-hole 21, making the first gap 11 and the second gap 22 interconnected. Then, put the insulator 2 in the hollow portion 31 of the metallic shell 3 and adjust the position of the terminal member 1 allowing the projecting members 35 of the hollow portion 31 to embed in the mating slots 25 correspondingly, and at the same time making sure that the third gap 34 is aligned with the first gap 11 and the second gap 22, and the outer side of the extending portion 23 is in close contact with the inner side of the cover 32 of the metallic shell 3. Refer to FIG. 8, one end of the wire stock 4 passes through the third gap 34, the second gap 2 and the first gap 11 in turn and contacts with the terminal member 1 finally. Then the packing of the wire stock 4 can be carried out. Refer to FIG. 7, the packing process of the wire stock 4 is as follows:

Firstly, twist the extending portion 23 around point C making the groove 231 contact with the wire stock 4; then twist the metallic shell 3 around part B making the cover 32 contact with the protrusion 232 of the extending portion 23, which further forces the insulator 2 to press the wire stock 4 tightly so that the wire stock 4 can conduct with the terminal member 1. Later, use two wings 321 of the cover 32 to fasten the hollow portion 31 and bend the first sheet 331 to prevent the hollow portion 31 from shaking, ensuring a reliable contact between the connector and its corresponding member; Finally, pack the wire stock 4 with the second sheet 332, so that the wire stock 4 can not be easily drawn out.

Through the embodiment described above, the connector of this invention has been sufficiently disclosed. While the description is an exemplification of the principles of the invention and is not intended to limit the invention to this particular embodiment, it is evident that many alternatives, modifications, and variations will be apparent to those skilled in the art.

U.S. Pat. No. 7,485,000 is hereby incorporated herein by reference in its entirety.

1. A coaxial electrical connector comprises:
a terminal member (1) having a first gap (11) for inserting a wire stock (4), a flat contact (13) which extends along the inserting direction of the wire stock (4) to support the wire stock (4), a fixing portion (15), and a connecting member (14) with an inserting gap (141);
an insulator (2) having a through-hole (21) for the terminal member (1) being fixed in by the fixing portion (15), and a second gap (22) interconnected with the first gap (11) for the wire stock (4) to pass through;
a metallic shell (3) having a third gap (34) aligned with the second gap (22) for the wire stock (4) to pass through and a hollow portion (32) for mounting the insulator (2);
wherein, the flat contact (13) is formed with frictional stripes (16) at the contacting surface with the wire stock (4).

2. The coaxial electrical connector of claim 1 wherein the frictional stripes (16) are formed by a plurality of elongated recesses (160) spaced lengthwise thereof.

3. The coaxial electrical connector of claim 1 wherein the fixing portion (15) comprises a pair of first crooked arms (150) extending upwards from one end of the flat contact (13) with the first gap (11) being formed between the opposite sides of the pair of first crooked arms (150) and the frictional strips (16) being formed adjacent to the first crooked arms (150).

4. The coaxial electrical connector of claim 3 wherein the pair of first crooked arms (150) are formed with a plurality of first blocking points (151) at the surface facing the insulator (2), the first blocking points (151) penetrating into the insulator (2) and interfering with the wall of the insulator (2) tightly.

5. The coaxial electrical connector of claim 3 wherein the fixing portion (15) further comprises a pair of second crooked arms (152) extending upwards from the other end of the flat contact (13) with a plurality of second blocking points (153) being formed at the surface facing the insulator (2) to enhance the interference between the fix portion (15) and the insulator (2).

6. The coaxial electrical connector of claim 1 wherein the flat contact (13) is provided with a sight hole (17).

7. The coaxial electrical connector of claim 1 wherein the connecting member (14) includes an inverted U-shaped portion defining a pair of legs (140) extending downwards from the two lateral sides of the flat contact (13) respectively with the inserting gap (141) which narrows gradually from the top to down being formed there between.

8. The coaxial electrical connector of claim 7 wherein the free end of each leg (140) bends away from the inserting gap (141) forming a crimping (142).

9. The coaxial electrical connector of claim 1 wherein the insulator (2) is formed with a linking hole (27).

10. The coaxial electrical connector of claim 1 wherein the connector further comprises an extending portion (23) with its lower end being connected with the insulator (2) and its upper end free, the extending portion (23) being twistable relative to the insulator (2) with its upper end having a groove (231) at the surface facing the wire stock (4) and a protrusion (232) at the surface facing the metallic shell (3).

11. The coaxial electrical connector of claim 1 wherein the insulator (2) further comprises a hollow and cone-shaped plug (26) beneath the through-hole (21) with part of its outer surface being a plane (260).

12. The coaxial electrical connector of claim 1 wherein the metallic shell (3) is further provided with a twistable cover (32) which envelopes one port of the hollow portion (31) when bending, and a packing member (33) extending upwardly from the upper end of the cover (32) for the wire stock (4) to be wrapped therein.

13. The coaxial electrical connector of claim 12 wherein the packing member (33) comprises a twistable first sheet (331) and a plurality of twistable second sheets (332) lying above the first sheet (331) with the joint of the first sheet (331) and the second sheet (332) being formed with tuck-ups (334).

14. The coaxial electrical connector of claim 13 wherein the first sheet (331) and the second sheet (332) both possess a bending notch (333) at the turning part.

15. The coaxial electrical connector of claim 13 wherein the second sheet (332) is formed with bulges (3321) at the inner side.

16. The coaxial electrical connector of claim 12 wherein the hollow portion (31) is formed with projecting members (35) at the inner side, while the insulator (2) is set with mating slots (25) accordingly for embedding the projecting members (35).

17. The coaxial electrical connector of claim 12 wherein the metallic shell (3) further comprises a pair of clamping arms (341) mounted on the outside wall of the hollow portion (31) with its distal end away from the hollow portion (31) bending inwards to form a hook (342) with the third gap (34) being formed between the pair of the clamping arms (341).

18. An electrical connector comprising:
a shell defining a shell cavity;
an insulator oriented within the shell cavity, the insulator defining an insulator cavity, the insulator comprising a positionable arm having first and second sides, the first side of said positionable arm comprising a groove, the second side of said positionable arm comprising a bulge, the bulge located opposite the groove; and
a terminal member oriented within the insulator cavity, the terminal member comprising a contact area, said contact area comprising at least one frictional stripe;
wherein the positionable arm is positioned to clamp a wire stock between the groove of the positionable arm and the contact area of the terminal member, and the bulge contacts a portion of the shell.

19. The electrical connector of claim 18, wherein said frictional stripe comprises an elongated recess formed in said contact area.
